(19) United States
(12) Patent Application Publication
(10) Pub. No.: US 2023/0184888 A1
(43) Pub. Date: Jun. 15, 2023

(54) RADAR ANGLE CALIBRATION SYSTEM, RADAR CHIP, AND DEVICE

(71) Applicant: CALTERAH SEMICONDUCTOR TECHNOLOGY (SHANGHAI), Shanghai (CN)

(72) Inventors: Yanqun ZHANG, Shanghai (CN); Yan ZHU, Shanghai (CN)

(21) Appl. No.: 18/167,035

(22) Filed: Feb. 9, 2023

Related U.S. Application Data
(63) Continuation of application No. PCT/CN2022/112803, filed on Aug. 16, 2022.

(30) Foreign Application Priority Data
Aug. 25, 2021 (CN) 2021109820.3

(51) Int. Cl. G01S 7/40

(52) U.S. Cl. CPC G01S 7/40; G01S 7/4026; G01S 7/4086

(57) ABSTRACT

A radar angle calibration system is provided according to the present disclosure, including a radar simulator, a receiving horn antenna, a transmitting horn antenna, a turntable, and a controller. The radar is arranged on the turntable, and the radar rotates along with the turntable. The controller is configured to gradually change angle of transmitting the signals with a preset angle step by the turntable to obtain spatial responses of the receiving antenna array corresponding to signal sources in different DoAs, and obtain a spatial response matrix of the receiving antenna array according to the spatial responses corresponding to the signal sources in different DoAs.

### CROSS REFERENCE TO RELATED APPLICATIONS

The present disclosure is a continuation of PCT Pat. Application No. PCT/CN2022/112803, entitled “RADAR ANGLE CALIBRATION SYSTEM, RADAR CHIP, AND DEVICE,” filed Aug. 16, 2022, which claims priority to Chinese patent application No. 202110981820.3, entitled “RADAR ANGLE CALIBRATION SYSTEM, RADAR CHIP, AND DEVICE,” filed Aug. 25, 2021, each of which is incorporated by reference herein in its entirety.

### TECHNICAL FIELD

The present disclosure relates to the technical field of radars, and in particular to a radar angle calibration system, a radar chip, and a device.

### BACKGROUND

With the continuous development of intelligent driving, more and more vehicles need to install a radar to identify obstacles. Therefore, the accuracy of the radar for obstacle identification directly determines the performance of automatic driving of the vehicles. The radar includes an antenna array, which includes multiple antenna units. For the far field of the antenna array, it can be approximately considered that spatial responses of the antenna array are basically independent of a distance to the antenna array, but only related to an angle relative to the antenna array.

In order to enable the radar to accurately obtain positions of obstacles (hereinafter referred to as signal sources) in practice, it is necessary for the radar to measure the angle of the signal sources. The performance of the radar for angle measurement largely depends on the accuracy of the spatial responses of a receiving antenna array. Therefore, it is necessary to calibrate the spatial responses of the receiving antenna array of the radar.

In some cases, an angle reflector, a radar, and a turntable are arranged in a large millimeter wave anechoic darkroom. The angle reflector is configured as a signal source, the radar is arranged on the turntable to control the turntable to rotate, and the radar rotates with the turntable, so that the radar can be stationary while the signal sources rotating. The radar transmits electromagnetic wave signals, the electromagnetic wave signals encounter the angle reflector, and echo signals are generated. In response to the angle reflector having special reflective characteristics, an angle at which the echo signals generated by the angle reflector reach the radar is equal to an angle at which the electromagnetic wave signals transmitted by the radar incident on the angle reflector. Therefore, an incident angle can be controlled to generate signals with different directions of arrival (DoA) indirectly, and the incident angle can be changed by rotating the radar with the turntable.

The accuracy of the above calibration system is poor.

### SUMMARY

In order to solve the above technical problem, a radar angle calibration system, a radar chip, and a device are provided according to the present disclosure, to accurately calibrate the angle of the radar.

The radar angle calibration system provided according to the embodiments of the present disclosure is applied to a radar with a receiving antenna array. The calibration system includes a radar simulator, a receiving horn antenna, a transmitting horn antenna, a turntable, and a controller. The radar is arranged on the turntable, and the radar rotates along with the turntable. The receiving horn antenna and the transmitting horn antenna are both connected to the radar simulator by a waveguide. The radar is configured to transmit signals, the receiving horn antenna is configured to receive the signals from the radar and transmit the signals to the radar simulator by the waveguide. The radar simulator is configured to simulate echo signals according to the signals from the receiving horn antenna and transmit the signals to the transmitting horn antenna by the waveguide, and the transmitting horn antenna is configured to transmit the echo signals to the radar. The controller is configured to drive the radar to gradually change angle of transmitting the signals with a preset angle step by the turntable to obtain spatial responses of the receiving antenna array corresponding to signal sources in different DoAs, and obtain a spatial response matrix of the receiving antenna array according to the spatial responses corresponding to the signal sources in different DoAs.

In some embodiments, the controller is configured to obtain echo signals received by each antenna unit in the receiving antenna array in each DoA, obtain frequency responses of the echo signals received by the each antenna unit by performing Fourier transformation on each of the echo signals, obtain phase responses of the each antenna unit according to the frequency responses of the echo signals received by the each antenna unit, and obtain the spatial responses of the receiving antenna according to the phase responses of the each antenna unit.

In some embodiments, the controller is configured to obtain a first phase response in a first DoA and a second phase response in a second DoA of the each antenna unit, the first DoA and the second DoA differ from each other by the preset angle step; the controller is configured to perform interpolation on the first phase response and the second phase response to obtain phase responses corresponding to x interpolation angles between the first DoA and the second DoA, and the x is a positive integer; the controller is configured to obtain the spatial response matrix after interpolation.

In some embodiments, the controller is configured to perform the interpolation as:

$$\frac{{w}_{x} - {w}_{0}}{{w}_{n} - {w}_{0}} = \frac{{θ}_{x} - {θ}_{0}}{{θ}_{n} - {θ}_{0}}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

In some embodiments, the controller is configured to perform the interpolation as:

$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

In some embodiments, the radar angle calibration system further includes a memory, where the controller is configured to store the spatial response matrix after interpolation in the memory, and obtain the spatial response matrix after interpolation from the memory in response to an angle of the radar needing to be calibrated.

In some embodiments, the radar angle calibration system further includes a memory, where the controller is configured to store the spatial response matrix before interpolation in the memory, obtain the spatial response matrix before interpolation from the memory in response to the angle of the radar needing to be calibrated, and perform interpolation on the spatial response matrix before interpolation to obtain the spatial response matrix after interpolation.

A radar chip is further provided according to some embodiments of the present disclosure, the radar chip includes a processor and a memory, where the memory is configured to store the spatial response matrix of the receiving antenna array obtained by the radar angle calibration system. The processor is configured to match signals to be measured obtained by a radar with a spatial response matrix of a receiving antenna array stored in the memory, and obtain phase responses matched with the signals to be measured from the spatial response matrix of the receiving antenna array, to obtain an angle of the signals to be measured.

A radar chip is further provided according to some embodiments of the present disclosure, the radar chip includes a processor and a memory; where the memory is configured to store the spatial response matrix of the receiving antenna array obtained by the radar angle calibration system. The processor is configured to obtain a first phase response in a first DoA and a second phase response in a second DoA of each antenna unit, the first DoA and the second DoA differ from each other by the preset angle step. The processor is configured to perform interpolation on the first phase response and the second phase response to obtain phase responses corresponding to x interpolation angles between the first DoA and the second DoA, and the x is a positive integer. The processor is configured to obtain the spatial response matrix after interpolation, match signals to be measured obtained by a radar with a spatial response matrix after interpolation, obtain phase responses matched with the signals to be measured from the spatial response matrix of the receiving antenna array, and obtain an angle of the signals to be measured according to the phase responses of the signals to be measured.

In some embodiments, the processor is configured to perform the interpolation as:

$$\frac{{w}_{x} - {w}_{0}}{{w}_{n} - {w}_{0}} = \frac{{θ}_{x} - {θ}_{0}}{{θ}_{n} - {θ}_{0}}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

In some embodiments, the processor is configured to perform the interpolation as:

$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

A device is further provided according to some embodiments of the present disclosure, the device includes a device main body; and the radar chip arranged on the device main body. The radar chip is configured to perform target measurement.

The present disclosure has at least the following advantages. In the radar angle calibration system provided according to the embodiments of the present disclosure, the controller is configured to drive the radar to rotate by changing the angle of the turntable, so that the angle of the radar is changed, to simulate that the radar is stationary while the signal source is rotating. The radar is measured during receiving the phase responses of the radar receiving antenna array at each angle, to obtain the spatial response matrix of each DoA. That is to say, the radar angle calibration system provided according to the embodiments of the present disclosure forms a spatial response matrix by measuring the spatial responses in the DoA one by one until the spatial responses in all DoAs within the field of view (FOV) range of the radar are obtained. Since the radar angle calibration system provided according to the embodiments of the present disclosure perform calibration angle by angle, which can also be referred to as point-by-point calibration. Since the accuracy of the radar angle calibration system provided according to the embodiments of the present disclosure is high, it can be considered that the obtained spatial response matrix can be directly used for angle calibration. For example, the spatial response matrix can be stored for angle measurement.

### BRIEF DESCRIPTION OF THE DRAWINGS

FIG. 1 is a schematic view of a radar angle calibration system provided according to some embodiments of the present disclosure;

FIG. 2 is a comparison curve between linear fitting in the prior art and point by point calibration provided according to some embodiments of the present disclosure;

FIG. 3 is a schematic view of another calibration system provided according to some embodiments of the present disclosure;

FIG. 4 is a schematic view of yet another calibration system provided according to some embodiments of the present disclosure;

FIG. 5 is a schematic view of a radar chip provided according to some embodiments of the present disclosure; and

FIG. 6 is a schematic view of another radar chip provided according to some embodiments of the present disclosure.

### DETAILED DESCRIPTION OF THE EMBODIMENTS

The technical solutions in the embodiments of the present disclosure will be described below in combination with the accompanying drawings in the embodiments of the present disclosure.

The words “first” and “second” in the following description are only used for description purposes, and cannot be understood as indicating or implying relative importance or implicitly indicating the quantity of indicated technical features. Thus, a feature defined as “first”, “second” or the like may explicitly or implicitly include one or more of the features. In the description of the present disclosure, unless otherwise specified, “multiple” means two or more.

In the present disclosure, unless otherwise specified and defined, the term “connection” should be understood in a broad sense. For example, “connection” may be a fixed connection, a detachable connection, or a whole. It may be directly connected or indirectly connected through intermediate media. In addition, the term “coupling” may be a means of realizing an electrical connection for signal transmission, and the term “coupling” may be a direct electrical connection or an indirect electrical connection through an intermediate medium.

In order to enable those skilled in the art to better understand the technical solution provided according to the embodiments of the present disclosure, technical terms in the art are introduced as follows.

The antenna Array is an antenna system consisting of at least two identical single antennas arranged in a certain rule. Each independent element is referred to as an array element or an antenna element. In response to the array elements (i.e., antenna elements) being arranged along a straight line or distributed on a plane, a linear array or a planar array are formed, respectively.

For far field of antenna array, it is assumed that r is a distance between a transmitting antenna array and a target to be measured. In response to r being greater than or equal to (2D²/λ), (λ is an electromagnetic wave length, and D is a size of the antenna array), it is approximately considered that the electromagnetic wave projected on the target to be measured is a plane electromagnetic wave, and the angular distribution of a radiation field intensity of the antenna array is basically independent of the distance r between the antenna arrays. Similarly, in response to the distance between the receiving antenna array and the target to be measured meeting above condition, the receiving antenna array will also receive the far field of the target to be measured.

Based on an array steering vector matrix of the receiving antenna array, the array spatial responses are amplitude phase responses of the same target from the far field received by each antenna unit in the receiving antenna array. Ideally, the amplitude responses of all antenna elements in the receiving antenna array are the same, but the phase responses are different, and the phase responses are only related to the angle of the target relative to the antenna array (i.e., the DoA) and positions of the antenna element in the array.

Array calibration is described here. In the receiving antenna array in a millimeter wave radar system, due to some non-ideal factors, the spatial responses of the actual antenna array will have a relatively large error with the spatial responses of the antenna array designed according to the theory. In this case, it is necessary to measure these errors and make compensation to ensure that the angle resolution processing can obtain accurate angle measurement. These errors include phase errors caused by the coupling between the receiving and transmitting circuits, amplitude errors caused by the coupling between the antennas, and phase errors and position errors of the antenna unit.

DOA is the abbreviation of direction of arrival.

FOV is the abbreviation of field of view.

In order to enable the radar to accurately obtain positions of obstacles (hereinafter referred to as the signal sources) in practice, it is necessary for the radar to measure the angle of the signal source. The performance of the radar for angle measurement mainly depends on the accuracy of the spatial response of the receiving antenna array. Therefore, it is necessary to calibrate the spatial response of the receiving antenna array of the radar.

Generally, the process of calibrating the spatial responses of the receiving antenna array of the radar is: an angle reflector, a radar, and a turntable are arranged in a large millimeter wave anechoic darkroom. The angle reflector is configured as a signal source, the radar is arranged on the turntable to control the turntable to rotate, and the radar rotates with the turntable, so that the radar can be stationary while the signal sources rotating. The radar transmits electromagnetic wave signals, the electromagnetic wave signals encounter the angle reflector, and echo signals are generated. In response to the angle reflector having special reflective characteristics, an angle at which the echo signals generated by the angle reflector reach the radar is equal to an angle at which the electromagnetic wave signals transmitted by the radar incident on the angle reflector. Therefore, an incident angle can be controlled to generate signals with different DoAs indirectly, and the incident angle can be changed by rotating the radar with the turntable. Since the angle reflector is a passive component, in order to ensure the strength of echo signals, it is necessary to arrange the angle reflectors with bigger size as signal sources. However, big angle reflectors will generate multiple reflection points, which will affect the accuracy of calibration. In addition, since the size of darkroom is generally not too big (such as 10 m to 50 m), angle calibration for distant (e.g., 100 m, 200 m, 300 m) targets will be limited.

The reason for the poor accuracy of the above calibration is that: in order to obtain accurate spatial responses of the antenna array, the following calibration methods should be combined with the above devices: 1) maximum likelihood calibration; 2) minimum square calibration; 3) linear fit.

In general, the mathematical models used for these calibration methods are as follows:

$$x = A s + n$$

Matrix A represents the spatial responses of the antenna array under ideal conditions, which is determined by the position of each array element in the antenna array Ψ and the angle of the signal source relative to the radar (i.e., the DoA) θ.

$$\text{A} \left(\text{Ψ}\right) = \left[\text{a} \left(\text{Ψ} , {θ}_{1}\right) \text{a} \left(\text{Ψ} , {θ}_{2}\right) ... \text{a} \left(\text{Ψ} , {θ}_{d}\right)\right]$$

θᵢ(i = 1,2, ..., d) represents d samples in all DoAs, and vector a(Ψ, θᵢ) represents the spatial responses in DoA θᵢ of the antenna array under ideal conditions.

$$\text{a} \left(\text{Ψ} , {θ}_{i}\right) = {\left[{e}^{j {ω}_{0} {τ}_{1} \left({θ}_{i}\right)} {e}^{j {ω}_{0} {τ}_{2} \left({θ}_{i}\right)} ... {e}^{j {ω}_{0} {τ}_{l} \left({θ}_{i}\right)}\right]}^{\text{T}}$$

l represents the number of antenna elements in the antenna array, ω₀ represents central frequency of incoming wave. Scalar τₖ(θᵢ) represents time delay of signals in the DoA θᵢ arriving an antenna unit k under ideal conditions.

$${τ}_{k} \left({θ}_{i}\right) = \left(1 / \text{c}\right) \left({x}_{k} sin {θ}_{i} + {y}_{k} cos {θ}_{i}\right)$$

Among them, c represents the speed of electromagnetic wave propagation, which may be the speed of light.

$$\text{Ψ} = {\left[{x}_{0} {x}_{1} ... {x}_{l} {y}_{0} {y}_{1} ... {y}_{l}\right]}^{\text{T}}$$

Vector Ψ represents the position of all antenna elements in the antenna array under ideal conditions, vector s represents signal sources in different DoAs, vector n represents noises, vector x represents the received signal on each antenna unit, and matrix Ae represents the spatial responses of the antenna array under actual conditions, which has the following relationship with the spatial response matrix A of the antenna array under ideal conditions:

$$\text{Ae =} \text{ΓΑ} \left(\text{Ψ}\right)$$

Matrix Γ represents the error matrix; Γ⁻¹ is the inverse matrix of the matrix Γ, represents the check matrix, which is represented by matrix G. Matrix A̅e̅ represents the spatial responses of the antenna array in the actual situation measured in experiments.

For the check matrix G obtained from the minimum square calibration, it is required to meet the requirement that

$${\left‖\text{A} \left(\text{Ψ}\right) - \text{G} \hat{\text{Ae}}\right‖}_{\text{F}}$$

reach minimum. In order to make matrix G have a unique solution, it is generally necessary to measure the spatial responses in different DoAs with the same number of antenna elements in the antenna array. This calibration method considers the errors caused by the coupling between amplitude, phase and receiving channels, but does not consider the errors that may exist between the antenna position and the ideal value when the actual antenna is manufactured. Therefore, the accuracy of calibration is poor.

The maximum likelihood calibration takes the error of the antenna position Ψ into consideration, error matrix Γ and antenna position Ψ are jointly solved to obtain r and Ψ, so that

$${\left‖\text{ΓΑ} \left(\text{Ψ}\right) - \hat{\text{Ae}}\right‖}_{F}$$

can reach minimum. This method is theoretically optimal compared with the minimum square calibration method. However, in order to solve r and Ψ, it is generally necessary to measure the spatial responses of antenna array in a lot of different DoAs in experiments, calibration time is longer, and the complexity of solution solving is higher. Due to high complexity of the solution solving, the optimal solution may not be obtained, which leads to poor accuracy of the calibration.

Linear fitting is a calibration method that only considers the phase error. The phase error may be attributed to the antenna position Ψ, or may be introduced by internal circuit of a transceiver. The spatial responses of antenna array measured in experiments to actual situation A̅e̅ is used to perform linear fitting to solve Γ (must be a diagonal matrix) and Ψ. This method can be considered as a simplified version of the maximum likelihood calibration, which is simple to solve and widely used in practice. However, since the linear fitting simplifies the error model, the relationship between the spatial responses of the antenna array and the DoA in the actual situation generally does not meet this linear relationship well, and the larger the coverage of the DoA, the more difficult it is to ensure this linear relationship, resulting in different calibration errors in different DoAs, which leads to poor calibration accuracy.

In summary, when the above “process of calibrating the spatial responses of the receiving antenna array of the radar” is adopted, since there is always a deviation from the measured matrix A̅e̅ to the matrix Ae, so no matter which calibration method above is combined, the deviation from the measured matrix A̅e̅ to the matrix Ae should be calculated. However, in the above calculation process of the deviation value, the accuracy of the calculation is poor due to various circumstances, so the accuracy of the calibration is likely to be poor.

In the radar angle calibration system provided according to some embodiments of the present disclosure, the spatial response matrix of the receiving antenna array of the radar is obtained, which may be implemented by directly obtaining Ae in formula (2) above, so that the accuracy of radar angle calibration is better.

The implementation manners of the technical solutions provided according to some embodiments of the present disclosure are described in detail in combination with the accompanying drawings.

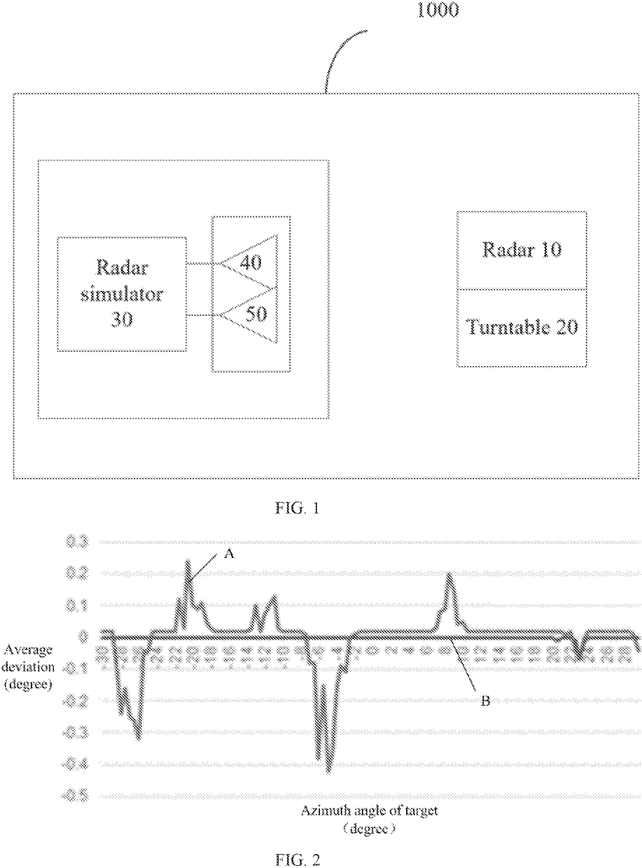

Reference is made to FIG. 1, which is a schematic view of a radar angle calibration system provided according to some embodiments of the present disclosure.

The radar angle calibration system provided according to some embodiments of the present disclosure is arranged in a millimeter wave darkroom 1000, and the radar angle calibration system is applied to a radar 10 with a receiving antenna array.

The radar angle calibration system includes a radar simulator 30, a transmitting horn antenna 40, a receiving horn antenna 50, a turntable 20, and a controller (not shown in the figure). It should be understood that the receiving antenna array 50 includes multiple antenna elements.

The radar 10 is arranged on the turntable 20, and the radar 10 rotates along with the turntable 20. In some embodiments of the present disclosure, the controller is configured to control the rotation of the turntable 20, and the radar 10 is fixedly connected to the turntable 20. In response to the turntable 20 rotating, the radar 10 synchronously rotates along with the turntable 20. The turntable 20 is 360 degrees rotatable. In some embodiments of the present disclosure, the controller is configured to control the turntable 20 to rotate, to drive the radar 10 to rotate, so that the scene where the radar is stationary while the signal source rotating is simulated, the different directions of the signal source in the radar 10 are simulated, that is, different angles and different DoAs are simulated.

The transmitting horn antenna 40 and the receiving horn antenna 50 are both connected to the radar simulator 30 by a waveguide.

In some embodiments of the present disclosure, both the transmitting horn antenna 40 and the receiving horn antenna 50 have desirable directivity.

The radar 10 is configured to transmit signals. The receiving horn antenna 50 is configured to receive the signals from the radar 10 and transmit the signals to the radar simulator 30 by the waveguide. The radar simulator 30 is configured to simulate echo signals according to the signals from the receiving horn antenna 50 and transmit the signals to the transmitting horn antenna 40 by the waveguide, and the transmitting horn antenna 40 is configured to transmit the echo signals to the radar 10.

The radar simulator 30 is configured to simulate signal sources with different distances, and energy of the signal sources are controllable. The controller is configured to control the rotation angle of radar 10 by the turntable 20 to obtain the calibration source signal of any signal source in any desired DoA, thus meeting the angle calibration requirements of the radar 10.

The controller is configured to drive the radar 10 by the turntable 20 to gradually change the angle of the transmitted signals with a preset angle step to obtain the spatial responses of the receiving antenna array corresponding to the signal source in different DoAs, and obtain a spatial response matrix of the receiving antenna array according to the spatial responses corresponding to the signal sources in different wave directions.

The spatial response matrix includes multiple columns, each of the multiple columns corresponds to multiple phase values, and the angle is obtained from difference of these phase values. Each rotation of the turntable 20 corresponds to an angle, and a spatial response vector will be obtained under the angle. Therefore, in response to the spatial response matrix being finally used for angle measurement, since each column in the spatial response matrix corresponds to the angle one by one, matching is performed in multiple stored spatial response vectors, the one-to-one correspondence between the spatial response vectors and the angles is used after a match is found in the spatial response vectors, a corresponding angle of the matched spatial response vector is obtained, so that the radar can obtain the angle of the target (signal source) to be measured.

The preset angle step can be set according to actual needs. It should be understood that the smaller the preset angle step is, the more accurate the spatial responses of the receiving antenna array are. In order to obtain a sufficiently accurate spatial response of the receiving antenna array, a sufficiently small preset angle step can be set, that is, the turntable 20 is controlled to rotate a certain angle each time according to the preset angle step, the corresponding spatial response vector of each angle is obtained. On the other hand, the smaller the preset angle step is, the longer the calibration process takes, and the larger the amount of data obtained through calibration. Therefore, the amount of data and accuracy are balanced according to actual needs to select the preset angle step. For example, the preset angle step may be 1 degree or 2 degrees.

The technical solutions provided according to some embodiments of the present disclosure is to change the angle of the turntable 20 and measure the spatial response of the receiving antenna array of the radar 10 in each DoA until the spatial response in all DoAs within the FOV range of the radar 10 is obtained, thus forming a spatial response matrix A̅e̅ₒ Since the technical solutions provided according to some embodiments of the present disclosure are to calibrate angle by angle, which is also referred to as point-by-point calibration, so it can be considered that the spatial response matrix A̅e̅ obtained^ equals to Ae, that is, the obtained spatial response matrix can be directly used for angle calibration, so that the accuracy of the calibration is higher. For example, the spatial response matrix can be stored without complex operations to solve the error matrix Γ and position of the antenna units Ψ. It is also unnecessary to use the above formula (2) to solve the actual spatial responses of the antenna array.

From FIG. 2, it can be seen that a comparison between the angle of the signal source is measured by the spatial response matrix obtained by the radar angle calibration system provided according to the present disclosure, and the angle of the signal source measured by the spatial response matrix calibrated by the above “process of calibrating the spatial responses of the receiving antenna array of the radar (that is, the process of calibrating the spatial responses of the receiving antenna array of the radar mentioned in the background technology)” combined with the spatial response matrix calibrated by the linear fitting method.

Curve A represents the error condition of angle calibration using the above “process of calibrating the spatial responses of the receiving antenna array of the radar” combined with the linear fitting method. It can be seen that the above “process of calibrating the spatial responses of the receiving antenna array of the radar” combined with the linear fitting method has a large error, and there are obvious fluctuations around 0, some angles are positive, some angles are negative, and the absolute value of the maximum deviation angle exceeds 0.4 degrees.

Curve B represents the point-by-point calibration provided according to the present disclosure. It can be seen that the error fluctuation is small, all of which fluctuate around 0, and the absolute value of the maximum deviation angle is less than 0.1 degrees. The angle calibrated in the technical solutions is more accurate, with obvious advantages.

In addition, compared with the calibration system using the angle reflector, the radar simulator in the embodiments does not need to adjust the physical size as a signal source in the scene where the echo signal strength needs to be adjusted. At the same time, the number of echo signal sources generated is predictable, and multiple reflection points will not be generated due to the large size of passive corner reflectors, thus ensuring the accuracy of calibration. In addition, since the simulated echo signal energy generated by the radar simulator is adjustable, there is no requirement on the size of the darkroom. For example, in a darkroom environment of a size of 10 m to 50 m, the echo signals of distant targets such as 100 m, 200 m and 300 m can be simulated, thus realizing the simulation calibration operation of multiple types (ranges) of targets.

The process of obtaining the spatial response matrix for the calibration system provided according to some embodiments of the present disclosure is described in details below.

Since the receiving antenna array includes multiple antenna units, the spatial response matrix includes the spatial response of each antenna unit. The process of obtaining the spatial response of each antenna unit is described as follows. Since positions of multiple antenna units are different, the signals reflected by the same signal source arrive at different antenna units with wave path difference, which corresponds to multiple phase differences.

In some embodiments of the present disclosure, the controller is configured to obtain echo signals received by each antenna unit in the receiving antenna array in each DoA, obtain frequency responses of the echo signals received by the each antenna unit by performing Fourier transformation on each of the echo signals, obtain phase responses of the each antenna unit according to the frequency responses of the echo signals received by the each antenna unit, and obtain the spatial responses of the receiving antenna according to the phase responses of the each antenna unit.

The close relationship between the accuracy of angle measurement and the preset angle step size is taken into consideration, the preset angle step size is generally x degrees, and the error of angle measurement ranges from -x/2 degrees to x/2 degrees. Therefore, if the angle measurement error is reduced, it is usually necessary to set a very small preset angle step size, which requires measuring more spatial responses in the DoA, resulting in a long calibration time or a big storage space.

Since the radar angle calibration system provided according to some embodiments of the present disclosure is configured to measure angles one by one, in order to shorten the measurement time as much as possible and ensure the accuracy of measuring angles, interpolation methods can be used to interpolate angles. Two interpolation methods provided according to some embodiments of the present disclosure are described as follows.

In some embodiments of the present disclosure, the controller is configured to perform interpolation the phase responses corresponding to two adjacent angles and obtain the phase responses corresponding to the interpolation. It should be noted that there is no limit to the number of interpolated angles between two adjacent measuring angles, which may be one or multiple.

In some embodiments of the present disclosure, the controller is configured to obtain a first phase response in a first DoA and a second phase response in a second DoA of the each antenna unit, the first DoA and the second DoA differ from each other by the preset angle step; the controller is configured to perform interpolation on the first phase response and the second phase response to obtain phase responses corresponding to x interpolation angles between the first DoA and the second DoA, and the x is a positive integer; the controller is configured to obtain the spatial response matrix after interpolation.

In the first interpolation method, the controller is configured to perform the interpolation as:

$$\frac{{w}_{x} - {w}_{0}}{{w}_{n} - {w}_{0}} = \frac{{θ}_{x} - {θ}_{0}}{{θ}_{n} - {θ}_{0}}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

The first interpolation method above directly uses phase response difference to obtain the phase response after interpolation, which is simple in calculation, and the phase response corresponding to the interpolated arrival direction can be obtained more quickly.

In the second interpolation method, the controller is configured to perform the interpolation as:

$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$

w0 represents a phase response in the first direction θ0 of arrival of each antenna unit;
wn represents a phase response in the second direction θn of arrival of each antenna unit;
$${θ}_{x} = {θ}_{0} + x ∗ \text{Δθ}$$
$$\text{Δθ} = \frac{{θ}_{n} - {θ}_{0}}{N}$$
N represents that there are N equal intervals between the first DoA and the second DoA, and N corresponds to the x interpolation angles, x=1, 2, ..., N-1; N is an integer greater than or equal to 2.

It should be noted that the second interpolation method above uses the sine difference of angles to obtain the phase responses after interpolation, which is slightly more complex than the first method in calculation, but the phase responses obtained is more accurate and closer to the measured angle.

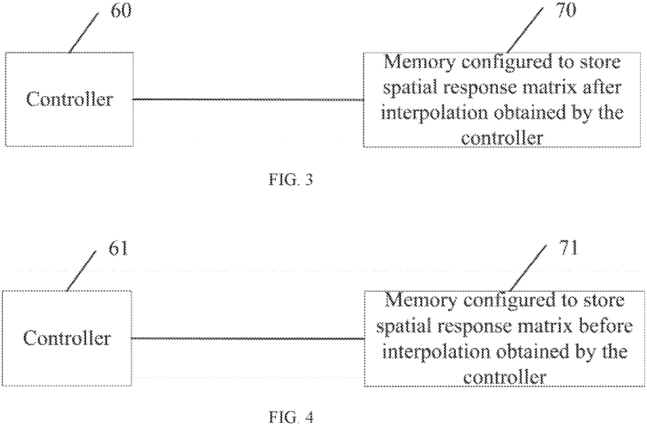

Reference is made to FIG. 3, which is a schematic view of another calibration system provided according to some embodiments of the present disclosure.

The radar angle calibration system provided according to some embodiments of the present disclosure further includes a memory 70, the memory 70 is configured to store the spatial response matrix after interpolation. It can be understood that, the spatial response matrix of the receiving antenna array of the radar is obtained in advance. In practical usage of the radar, the spatial response matrix obtained in advance can be directly used to measure the DoA of the signal source.

In some embodiments, in practical usage of the radar, in order to obtain the DoA (i.e., angle) of the signal source more quickly, a controller 60 is configured to store the spatial response matrix after interpolation that can be directly used in the memory 70, so that the controller 60 can directly call the spatial response matrix after interpolation. The controller 60 is configured to store the spatial response matrix after interpolation in the memory 70, and obtain the spatial response matrix after interpolation from the memory 70 in response to the radar angle needing to be calibrated.

Reference is made to FIG. 4, which is a schematic view of yet another calibration system provided according to some embodiments of the present disclosure.

In other embodiments, a controller 61 is configured to store the spatial response matrix before interpolation in a memory 71. In response to the radar angle needing to be calibrated, the controller 61 is configured to obtain the spatial response matrix before interpolation from the memory 71, perform interpolation on the spatial response matrix before interpolation to obtain the spatial response matrix after interpolation, so that the spatial response matrix after interpolation can be used to measure the angle of the signal source. For example, the radar is arranged on the vehicle, the receiving antenna array on the radar can accurately measure the angle of surrounding obstacles relative to the radar, that is, accurately measure the DoA, to guide the vehicle to avoid obstacles. Since the radar can accurately obtain the angle of obstacles relative to the radar, the travelling of an autonomous vehicle is guided.

Based on the radar angle calibration system provided according to some embodiments of the present disclosure above, a radar chip is further provided according to some embodiments of the present disclosure, and the radar chip is described in detail below in combination with the accompanying drawings.

It should be understood that the radar in some embodiments of the present disclosure may be an AiP (antenna in package), a chip, an AoC (Antenna on Chip) or the like, or may be a structure including a radar chip and a receiving antenna array, that is, the radar chip is configured to control the receiving antenna array, control the receiving antenna array to transmit and receive signals, and thus realizing the obstacle measurement by the radar.

The radar chip provided according to some embodiments of the present disclosure includes a processor and a memory, where the memory is configured to store the spatial response matrix before interpolation obtained by the radar angle calibration system provided according to some embodiments above, and is further configured to store the spatial response matrix after interpolation obtained by the above radar angle calibration system, which are described below.

It should be noted that in response to the radar chip being a SoC chip, the radar chip is also configured to perform Fourier transform on each echo signal to obtain the frequency response of the echo signal of each antenna unit, obtain the phase response of each antenna unit according to the frequency response of the echo signal of each antenna unit, obtain the spatial responses of the receiving antenna array according to the phase response of each antenna unit, and obtain the spatial response matrix. That is, in the controller in the above radar angle calibration system, the SoC chip is configured to obtain the spatial responses of the receiving antenna array and the spatial response matrix.

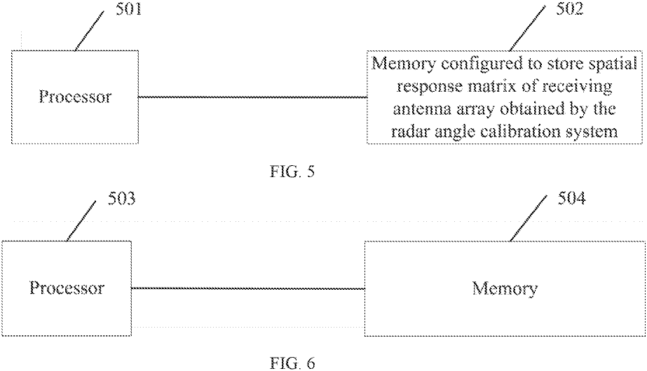

Reference is made to FIG. 5, which is a schematic view of a radar chip provided according to some embodiments of the present disclosure.

The radar chip provided according to some embodiments of the present disclosure includes a processor 501 and a memory 502.

The memory 502 provided according to some embodiments of the present disclosure is configured to store the spatial response matrix of the receiving antenna array obtained by the radar angle calibration system in advance. The spatial response matrix may be either a spatial response matrix before interpolation or a spatial response matrix after interpolation. In response to the spatial response matrix stored in memory 502 being the spatial response matrix before interpolation, in practical use, the stored spatial response matrix is interpolated, and the spatial response matrix after interpolation is updated to the memory 502 to replace the original stored spatial response matrix before interpolation based on the actual disclosure scenario. Subsequently, the angle of the DoA is measured by the radar chip based on the updated spatial response matrix after interpolation, that is, the spatial response matrix stored in the memory 502 may be updated based on the actual requirements, so that the stored spatial response matrix data can adapt to the present disclosure scenario requirements. In addition, in response to the preset angle step being set small enough when calibrating the spatial response matrix before interpolation, it is not necessary to perform interpolation, and an accurate spatial response matrix can be obtained. The DoA obtained by using the accurate spatial response matrix is also accurate. In response to the spatial response matrix being stored in the memory 502 is the spatial response matrix after interpolation, the radar will directly use the spatial response matrix after interpolation to obtain the DoA to measure the angle.

The processor 501 is configured to match signals to be measured obtained by a radar with a spatial response matrix of a receiving antenna array stored in the memory 502, and obtain phase responses matched with the signals to be measured from the spatial response matrix of the receiving antenna array, to obtain an angle of the signals to be measured.

It should be understood that since each column of the spatial response matrix stored in memory 502 has a one-to-one correspondence with the DoA, in practical usage of the radar, the processor 501 is further configured to obtain the spatial response vector corresponding to the signal source (i.e., simulated echo signal) currently measured by the radar, and match the spatial response vector currently measured with the spatial response vector in each DoA stored in memory 502. That is, energy values in different DoAs are obtained, and the DoA with the maximum energy value is taken as the DoA currently measured by the radar.

Since the calibrated spatial response matrix is stored in the memory of the radar chip, the DoA measured by the radar can be obtained more accurately.

The memory 502 included in the radar chip described above can store the spatial response matrix before interpolation. In practical usage, the processor 501 of the radar chip can perform interpolation according to the spatial response matrix before interpolation to obtain the spatial response matrix after interpolation. It should be understood that the processor 501 can also directly use the spatial response matrix before interpolation to perform angle measurement without obtaining the spatial response matrix after interpolation, in response to the radar angle calibration system performing angle calibration, as long as the preset angle step is set small enough, and the obtained spatial response matrix is accurate enough.

Refer to FIG. 6, which is a schematic view of another radar chip provided according to some embodiments of the present disclosure.

A radar chip is further provided according to some embodiments of the present disclosure, the radar chip includes a processor 503 and a memory 504.

The memory 504 is configured to store instructions that can be executed by at least one processor 503 to enable the at least one processor 503 to perform the following method of obtaining the angle of the signal to be measured. In an example, the memory 504 is configured to store the spatial response matrix of the receiving antenna array obtained by the radar angle calibration system in the above embodiments of the present disclosure.

The processor 503 is configured to configured to obtain a first phase response in a first DoA and a second phase response in a second DoA of each antenna unit, the first DoA and the second DoA differ from each other by the preset angle step. The processor is configured to perform interpolation on the first phase response and the second phase response to obtain phase responses corresponding to x interpolation angles between the first DoA and the second DoA, and the x is a positive integer. The processor is configured to obtain the spatial response matrix after interpolation, match signals to be measured obtained by a radar with a spatial response matrix after interpolation, obtain phase responses matched with the signals to be measured from the spatial response matrix of the receiving antenna array, and obtain an angle of the signals to be measured according to the phase responses of the signals to be measured.

In the first interpolation method, the processor 503 is configured to perform the interpolation as:

$$\frac{{w}_{x} - {w}_{0}}{{w}_{n} - {w}_{0}} = \frac{{θ}_{x} - {θ}_{0}}{{θ}_{n} - {θ}_{0}}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

In the second interpolation method, the processor 503 is configured to perform the interpolation as:

$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$

w0 represents a phase response in the first direction θ0 of arrival of each antenna unit;
wn represents a phase response in the second direction θn of arrival of each antenna unit;
$$\begin{matrix}{θ}_{x} = {θ}_{0} + x ∗ \text{Δθ} \\ \text{Δθ=} \frac{{θ}_{n} - {θ}_{0}}{N}\end{matrix}$$
N represents that there are N equal intervals between the first DoA and the second DoA, and N corresponds to the x interpolation angles, x=1, 2, ..., N-1; N is an integer greater than or equal to 2.

It should be noted that the radar chip described in the embodiments of the radar angle calibration system of the present disclosure and the radar chip shown in FIG. 5 and FIG. 6 can be the same radar chip or the same batch of radar chips. For example, for the same batch of radar chips, one or more radar chips can be selected as test chips to measure the spatial response error of the receiving antenna array of each test chip caused by non-ideal factors such as production process in an ideal environment such as a darkroom. Also, the average value of the spatial response error of the receiving antenna array of each test chip is taken as a reference spatial response error, and the reference spatial response error is prestored into the remaining or all radar chips of the batch, so that in practical target measurement done by the radar chip, phase compensation of the received echo signal can be made by using the reference spatial response error. Subsequently, the compensated echo signal is used to measure the angle of target, thus effectively improving the accuracy of target measurement.

In some embodiments, based on parameters of the production process, such as a production serial number, combined with the spatial response error of the receiving antenna array of each test chip, a function related to the change of the production process parameters (i.e., the trend of change) can be obtained, and the function can be stored in the remaining or all radar chips of the batch, so that when any radar chip performs the actual target measurement, the function and a corresponding production process parameters are used to obtain the corresponding spatial response error of the radar chip, and the phase compensation of the received echo signal is performed based on the corresponding spatial response error. Of course, in response to the phase compensation being required, the spatial response error corresponding to each radar chip can also be prestored into its own memory to facilitate direct call.

Based on the radar chip provided according to some embodiments above, a device is further provided according to some embodiments of the present disclosure, the device includes a device main body and radar chip provided according to any embodiment of the present disclosure. The radar chip arranged on the device main body, and is configured to perform target measurement.

The device main body provided according to some embodiments of the present disclosure can be components and products in fields such as intelligent housing, transportation, smart home, consumer electronics, monitoring, industrial automation, in cabin measurement, health care, etc. For example, the device main body may be an intelligent transportation device (e.g., a vehicle, a bicycle, a motorcycle, a ship, a subway, a train, etc.), a security device (e.g., a camera), a liquid level/flow rate measurement device, an intelligent wearable device (e.g., a bracelet, a pair of glasses, etc.), a smart home device (e.g., a television, an air conditioner, a smart light, etc.), various communication devices (e.g., a mobile phone, a tablet, etc.), as well as a road gate, an intelligent traffic indicator, an intelligent sign, a traffic camera, and various industrial mechanical arms (or robots) can also be used to measure various instruments for vital parameters and various devices equipped with such instruments, such as car cabin measurement, indoor personnel monitoring, intelligent medical equipment, etc.

In response to the device main body being a vehicle, the automatic driving is realized by the radar chip, that is, it has more obvious advantages when applied to automatic driving vehicles. The processor in the radar chip is configured to compensate the echo signals according to the interpolated spatial response matrix after interpolation or the spatial response matrix before interpolation stored in the memory, and perform target angle measurement based on the compensated echo signals, thus improving the accuracy of obstacle measurement. That is, the DoA of the obstacle, or the angle of the obstacle relative to the radar, is accurately obtained to guide the vehicle to avoid obstacles and effectively improve the safety of automatic driving.

It should be understood that in the present disclosure, “at least one (item)” refers to one or more, and “multiple” refers to two or more. “And/or” is used to describe the association relationship of related objects, indicating that there can be three kinds of relationships. For example, “A and/or B” can indicate that there are only A, only B, and both A and B, where A and B may be singular or plural. The character “/” generally indicates that the context object is an “or” relationship. “At least one of the following” or its similar expression refers to any combination of these items, including any combination of single items or plural items. For example, at least one item (s) of a, b, or c can represent: a, b, c, “a and b”, “a and c”, “b and c”, or “a and b and c”, where a, b, c may be single or multiple.

The above descriptions are only preferred embodiments of the present disclosure, and do not limit the present disclosure in any form. Although the present disclosure has disclosed in preferred embodiments above, it is not intended to limit the present disclosure. Any person skilled in the art, without departing from the scope of the technical solution of the present disclosure, may make many possible changes and modifications to the technical solutions of the present disclosure by using the methods and technical contents disclosed above, or modify it into equivalent embodiments of equivalent changes. Therefore, any simple modification, equivalent change, and modification to the above embodiments according to the technical essence of the present disclosure without departing from the content of the technical solution of the present disclosure are still within the scope of protection of the technical solution of the present disclosure.

What is claimed is:

1. A radar angle calibration system, applied to a radar with a receiving antenna array including a plurality of antenna units, the radar angle calibration system comprising: a radar simulator, a receiving horn antenna, a transmitting horn antenna, a turntable, and a controller; wherein:
the radar is arranged on the turntable, and the radar rotates along with the turntable;
the receiving horn antenna and the transmitting horn antenna are both connected to the radar simulator by a waveguide;
the radar is configured to transmit signals, the receiving horn antenna is configured to receive the signals from the radar and transmit signals to the radar simulator via the waveguide, the radar simulator is configured to simulate echo signals according to the signals from the receiving horn antenna and transmit the echo signals to the transmitting horn antenna via the waveguide, and the transmitting horn antenna is configured to transmit the echo signals to the radar;
the controller is configured to control the turntable to drive the radar to gradually change an angle of transmitting signals with a preset angle step to obtain spatial responses of the receiving antenna array corresponding to signal sources in different directions of arrival (DoA), and is configured to obtain a spatial response matrix of the receiving antenna array according to the spatial responses corresponding to the signal sources in different DoAs.

2. The radar angle calibration system according to claim 1, wherein the controller is configured to obtain echo signals received by each of the plurality of antenna units in the receiving antenna array in each DoA, obtain frequency responses of the echo signals received by each of the plurality of antenna units by performing Fourier transformation on each of the echo signals, obtain phase responses of each of the plurality of antenna units according to the frequency responses of the echo signals received by each of the plurality of antenna units, and obtain the spatial responses of the receiving antenna according to the phase responses of each of the plurality of antenna units.

3. The radar angle calibration system according to claim 1, wherein the controller is configured to obtain a first phase response in a first DoA and a second phase response in a second DoA of each of the plurality of antenna units, the first DoA and the second DoA differ from each other by the preset angle step; the controller is configured to perform interpolation on the first phase response and the second phase response to obtain phase responses corresponding to x interpolation angles between the first DoA and the second DoA, and the x is a positive integer; the controller is configured to obtain the spatial response matrix after interpolation.

4. The radar angle calibration system according to claim 3, wherein the controller is configured to perform the interpolation as:
$$\frac{{w}_{x} - {w}_{0}}{{w}_{n} - {w}_{0}} = \frac{{θ}_{x} - {θ}_{0}}{{θ}_{n} - {θ}_{0}}$$
w₀ represents a phase response in the first direction θ₀ of arrival of each of the plurality of antenna units;
wₙ represents a phase response in the second direction θₙ of arrival of each of the plurality of antenna units;
$${θ}_{x} = {θ}_{0} + x ∗ Δ \text{θ}$$
$$Δ \text{θ=} \frac{{θ}_{n} - {θ}_{0}}{N}$$
N represents that there are N equal intervals between the first DoA and the second DoA, and N corresponds to the x interpolation angles, x=1, 2, ..., N-1; N is an integer greater than or equal to 2.

5. The radar angle calibration system according to claim 3, wherein the controller is configured to perform the interpolation as:
$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$
w₀ represents a phase response in the first direction θ₀ of arrival of each of the plurality of antenna units;
wₙ represents a phase response in the second direction θₙ of arrival of each of the plurality of antenna units;
$${θ}_{x} = {θ}_{0} + x ∗ Δ \text{θ}$$
$$Δ \text{θ=} \frac{{θ}_{n} - {θ}_{0}}{N}$$
N represents that there are N equal intervals between the first DoA and the second DoA, and N corresponds to the x interpolation angles, x=1, 2, ..., N-1; N is an integer greater than or equal to 2.

6. The radar angle calibration system according to claim 3, further comprising a memory;
wherein the controller is configured to store the spatial response matrix after interpolation in the memory, and obtain the spatial response matrix after interpolation from the memory in response to a radar angle needing to be calibrated.

7. The radar angle calibration system according to claim 3, further comprising a memory;
wherein the controller is configured to store the spatial response matrix before interpolation in the memory, obtain the spatial response matrix before interpolation from the memory in response to a radar angle needing to be calibrated, and perform interpolation on the spatial response matrix before interpolation to obtain the spatial response matrix after interpolation.

8. The radar angle calibration system according to claim 1, wherein both the transmitting horn antenna 40 and the receiving horn antenna 50 have desirable directivity.

9. The radar angle calibration system according to claim 1, wherein the radar simulator is configured to simulate signal sources with different distances, and energy of the signal sources are controllable.

10. The radar angle calibration system according to claim 1, wherein the preset angle step is 1 degree or 2 degrees.

11. A radar chip, comprising a processor and a memory;
wherein the memory is configured to store the spatial response matrix of the receiving antenna array obtained by the radar angle calibration system according to claim 1;
the processor is configured to match signals to be measured obtained by a radar with a spatial response matrix of a receiving antenna array stored in the memory, and obtain phase responses matched with the signals to be measured from the spatial response matrix of the receiving antenna array, to obtain an angle of the signals to be measured.

12. The radar chip according to claim 11, wherein the memory is configured to store the spatial response matrix of the receiving antenna array obtained by the radar angle calibration system according to claim 2.

13. The radar chip according to claim 11, wherein the memory is configured to store the spatial response matrix of the receiving antenna array obtained by the radar angle calibration system according to claim 3.

14. The radar chip according to claim 11, wherein the memory is configured to store the spatial response matrix of the receiving antenna array obtained by the radar angle calibration system according to claim 4.

15. The radar chip according to claim 11, wherein the memory is configured to store the spatial response matrix of the receiving antenna array obtained by the radar angle calibration system according to claim 5.

16. A radar chip, comprising a processor and a memory;
wherein the memory is configured to store the spatial response matrix of the receiving antenna array obtained by the radar angle calibration system according to claim 1, the receiving antenna array comprises a plurality of antenna units;
the processor is configured to obtain a first phase response in a first DoA and a second phase response in a second DoA of each of the plurality of antenna units, the first DoA and the second DoA differ from each other by the preset angle step; the processor is configured to perform interpolation on the first phase response and the second phase response to obtain phase responses corresponding to x interpolation angles between the first DoA and the second DoA, and the x is a positive integer; the processor is configured to obtain the spatial response matrix after interpolation, match signals to be measured obtained by a radar with a spatial response matrix after interpolation, obtain phase responses matched with the signals to be measured from the spatial response matrix of the receiving antenna array, and obtain an angle of the signals to be measured according to the phase responses of the signals to be measured.

17. The radar chip according to claim 16, wherein the memory is configured to store the spatial response matrix of the receiving antenna array obtained by the radar angle calibration system according to claim 2.

18. The radar chip according to claim 16, wherein the processor is configured to perform the interpolation as:
$$\frac{{w}_{x} - {w}_{0}}{{w}_{n} - {w}_{0}} = \frac{{θ}_{x} - {θ}_{0}}{{θ}_{n} - {θ}_{0}}$$
w₀ represents a phase response in the first direction θ₀ of arrival of each of the plurality of antenna units;
wₙ represents a phase response in the second direction θₙ of arrival of each of the plurality of antenna units;
$${θ}_{x} = {θ}_{0} + x ∗ Δ \text{θ}$$
$$Δ \text{θ=} \frac{{θ}_{n} - {θ}_{0}}{N}$$
N represents that there are N equal intervals between the first DoA and the second DoA, and N corresponds to the x interpolation angles, x=1, 2, ..., N-1; N is an integer greater than or equal to 2.

19. The radar chip according to claim 16, wherein the processor is configured to perform the interpolation as:
$$\frac{{w}_{x} - {w}_{0}}{{w}_{n} - {w}_{0}} = \frac{sin \left({θ}_{x}\right) - sin \left({θ}_{0}\right)}{sin \left({θ}_{n}\right) - sin \left({θ}_{0}\right)}$$
w₀ represents a phase response in the first direction θ₀ of arrival of each of the plurality of antenna units;
wₙ represents a phase response in the second direction θₙ of arrival of each of the plurality of antenna units;
$${θ}_{x} = {θ}_{0} + x ∗ Δ \text{θ}$$
$$Δ \text{θ=} \frac{{θ}_{n} - {θ}_{0}}{N}$$
N represents that there are N equal intervals between the first DoA and the second DoA, and N corresponds to the x interpolation angles, x=1, 2, ..., N-1; N is an integer greater than or equal to 2.

20. A device, comprising:
a device main body; and
the radar chip according to claims 16 arranged on the device main body;
wherein the radar chip is configured to perform target measurement.
